(19) United States
(12) Patent Application Publication
(10) Pub. No.: US 2006/0253803 A1
(43) Pub. Date: Nov. 9, 2006

(54) Directional I-beam cursor

(76) Inventor: Bjorn Eric Pekka Backlund, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/429,538

(22) Filed: May 5, 2006

Related U.S. Application Data
(60) Provisional application No. 60/678,513, filed on May 6, 2005.
(60) Provisional application No. 60/678,605, filed on May 6, 2005.

(51) Int. Cl. G06F 3/00

(52) U.S. Cl. 715/856

(57) ABSTRACT

Systems and methods for configuring and displaying a multi-state cursor to process a document are described. A software text editor such as a word processor, html editor, or other WYSIWYG (What You See Is What You Get) style editor for processing/manipulation of text using software include the multi-state cursor. In general, the cursor can be configured as any movable marker or pointer that indicates the position of a pointing device such as a mouse or set of arrow keys.

### CROSS-REFERENCE TO RELATED APPLICATIONS

This application claims the benefits of priority of co-pending U.S. Provisional Patent Application Ser. No. 60/678,513, filed May 6, 2005, entitled “Directional I-Beam Cursor”, and U.S. Provisional Patent Application Ser. No. 60/678,605, filed May 6, 2005, entitled “Visual Document Structure Indicator”. The disclosures of the above-referenced patent applications are hereby incorporated by reference.

### FIELD OF THE INVENTION

The present invention relates generally to a multi-state cursor, and more specifically, to processing a document using such a multi-state cursor.

### RELATED ART

Many text editors apply style attributes to text such as Bold or Italic. This is accomplished by using hidden tag attributes that do not always appear in the editor interface, but allows the text to take on the attribute by displaying the text appropriately. Although this method is effective, it makes editing of existing documents with hidden attributes difficult as it is not easily discernable where the attribute mark-up begins or ends. Thus, for example, if the cursor is placed at the end of a bold section, there is no easy way to determine whether the subsequently-typed characters will be bold or not.

### SUMMARY

Embodiments of the invention include systems and methods for configuring and displaying a multi-state cursor to process a document. One embodiment is a software text editor such as a word processor, html editor, or other WYSIWYG (What You See Is What You Get) style editor for processing/manipulation of text using software including the multi-state cursor. In general, the cursor can be configured as any movable marker or pointer that indicates the position of a pointing device such as a mouse or set of arrow keys.

One embodiment is a method for processing a document represented by document data including characters and attributes by configuring a multi-state cursor. The method includes: manipulating and storing document data according to user input; processing the document data to display content of the processed document data on a display pane; configuring and displaying the multi-state cursor in the content display of the display pane to indicate what attributes will be attributed to a character entered at the current cursor position; transitioning the multi-state cursor from one state to another state when the cursor encounters an attribute change in the content display; and modifying a configuration of the multi-state cursor when the cursor transitions from one state to another state, wherein the configuration of the multi-state cursor is modified to enable visual identification of the attribute change.

A further embodiment is a data processing system for processing a document. The system includes a user interface configured to receive user input; a document data storage configured to receive and store document data from the document; a data manipulator configured to receive the document data and the user input, said data manipulator operating to manipulate the received document data according to the user input, and to store the manipulated document data in said document data storage; and a data display unit configured to process the document data to display content of the processed document data on a display pane, said data display unit including a cursor display unit configuring and displaying the multi-state cursor in the content display of the display pane. The cursor display unit includes a state transitioning unit configured to track the current attribute state of the position of the cursor in the display according to the corresponding location in the underlying document data as the cursor traverses the underlying document data; and a configuration modifier to modify a configuration of the multi-state cursor when the cursor transitions from one state to another state. The configuration of the multi-state cursor is modified to enable visual identification of the attribute change.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A is a graphical representation of a relatively simple structured document represented in a tree format.

FIG. 1B is a block diagram of a data processing system which can process a document such as the structured document shown in FIG. 1A.

FIG. 1C is a detailed block diagram of a data display unit shown in FIG. 1B.

FIG. 1D is a detailed block diagram of a cursor display unit shown in FIG. 1C.

FIG. 2 shows a standard single state I-beam cursor used in many editors.

FIG. 3 shows one configuration of a state 1 standard cursor of a three-state cursor.

FIG. 4 shows one configuration of a state 2 left directional cursor of a three-state cursor.

FIG. 5 shows one configuration of a state 3 right directional cursor of a three-state cursor.

FIG. 6A shows a representation of a computer system and a user.

FIG. 6B shows a block diagram of one embodiment of the computer system in FIG. 6A, including an integrated document editor.

### DETAILED DESCRIPTION

Embodiments described herein provide systems and methods for configuring and displaying a multi-state cursor to process a document. In one embodiment, the multi-state cursor is used in a software text editor such as a word processor, html editor, or other WYSIWYG (What You See Is What You Get) style editor for processing/manipulation of text using software. For example, one such editor is described in U.S. patent application Ser. No. ______, entitled “Visual Document Structure Indicator System”, filed concurrently with this application and hereby incorporated by reference. In general, the cursor can be configured as any movable marker or pointer that indicates the position of a pointing device such as a mouse or set of arrow keys.

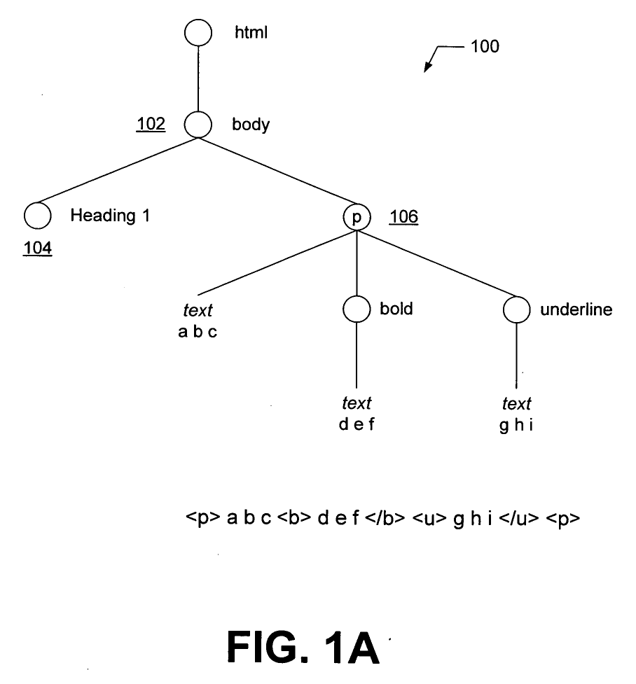

FIG. 1A is a graphical representation of a relatively simple structured document represented in a tree format 100. In the illustrated example, the structured document is an Extensible HyperText Markup Language (XHTML) document. The body 102 of the document includes a heading 104 and a single paragraph 106 represented by ‘p’. The paragraph 106 includes plain text ‘abc’ followed by bold text ‘def’ followed by underlined text ‘ghi’. When this document is displayed, the display software traverses the tree 100 in the order from top to bottom and left to right. Therefore, the execution of this document would be displayed as ‘abcdefghi’. However, when the editor is displaying the contents of the document along with tags, the display is as shown at the bottom of FIG. 1A:
<p>abc<b>def</b><u>ghi</u><p>.

FIG. 1B is a functional block diagram of a data processing system 120 which can process a document such as the structured document 100 shown in FIG. 1A. In the illustrated embodiment of FIG. 1B, the data processing system 120 includes a data manipulator 122, a user interface 124, and a data display unit 126.

The user interface 124 receives the input from the user and sends the input either to the data display unit 126 to be processed and displayed and/or to the data manipulator 122 to manipulate the data. The user input can be a command, content (e.g., text), or other related input. In general the system performs editing functions which include, but are not limited to, inserting, deleting, copying and changing attributes. The data manipulator 122 receives document data (e.g., data from document 100), which may include text content, document structure data, and other related data such as metadata, from a document data storage 130, and manipulates the received document data according to the user input. The manipulated document data is then stored in the document data storage 130. The data display unit 126 receives the user input from the user interface 124 and the document data from the storage 130, and processes the user input and the document data to generate a visual representation of the document data. The data display unit 126 displays various components of the processed user input and the document data on a display pane 128 in a manner which will be described in more detail below.

As illustrated in FIG. 1C, for example, the data display unit 116 includes a content display unit 140, a structure display unit 150, and a cursor display unit 160. In one embodiment, the content display unit 140 displays the text content of the document data; the structure display unit 150 displays the structure of the document data; and the cursor display unit 160 configures and displays the three-state cursor. In examples described in more detail below, the cursor display unit 160 configures and displays the three-state cursor such that the cursor indicates a current editing state. In other words, the cursor provides a visual indication of what attributes will be attributed to a character entered at the current cursor position.

FIG. 1D is a detailed block diagram of the cursor display unit 160 according to one embodiment. In the illustrated embodiment, the cursor display unit 160 includes a state transitioning unit 162 configured to track the current attribute state of the position of the cursor in the display according to the corresponding location in the underlying document data as the cursor traverses the underlying document data. A configuration modifier 164 modifies a configuration (visual representation) of the multi-state cursor when the cursor transitions from one attribute state to another attribute state. The configuration of the multi-state cursor is modified to provide a visual indication of the attribute change.

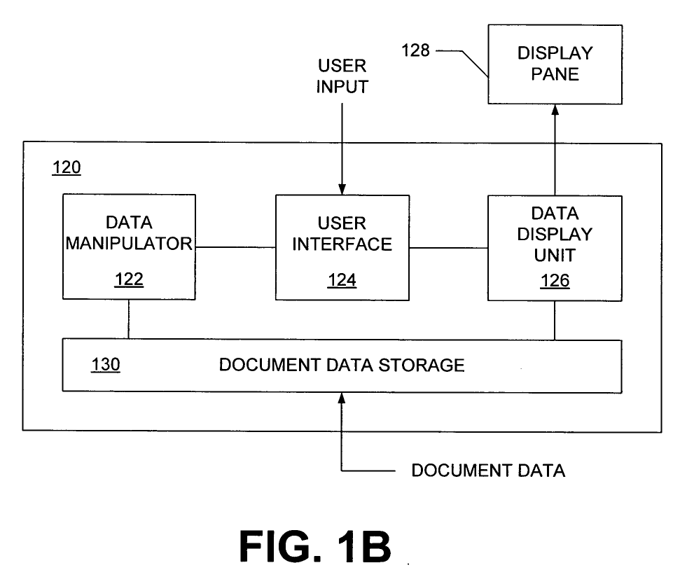

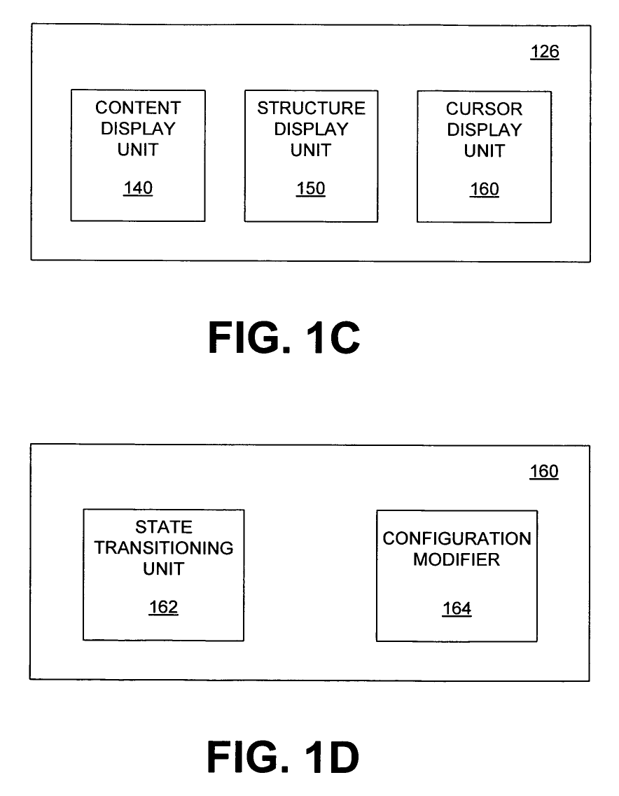

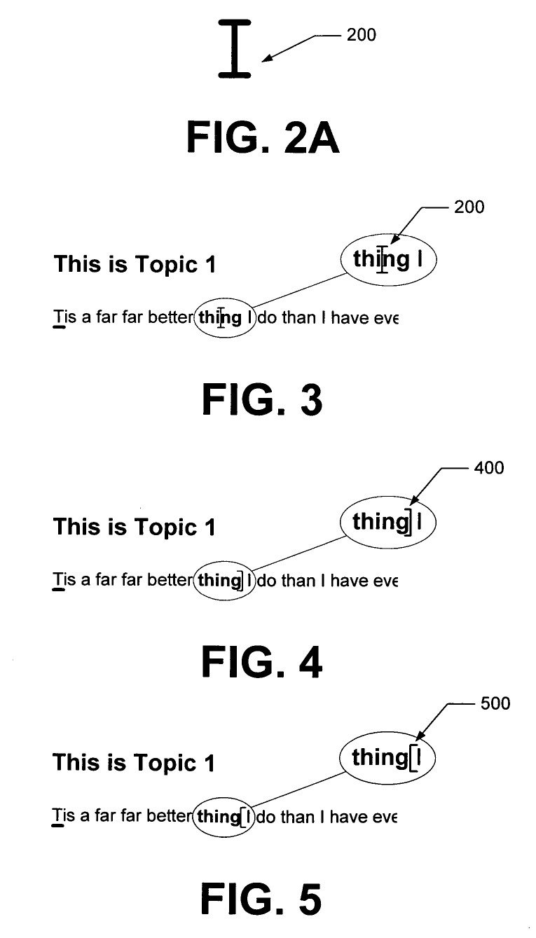

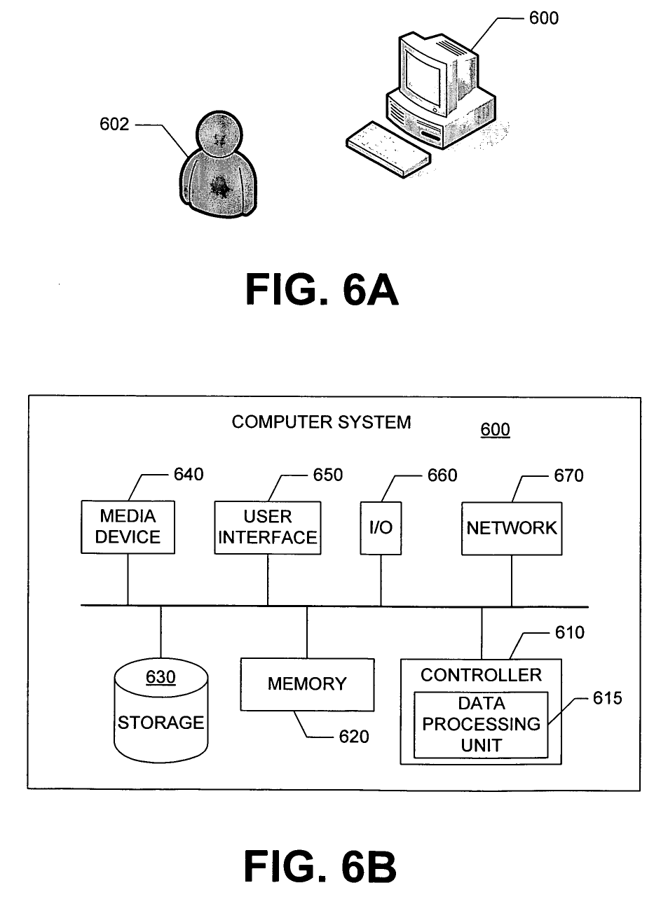

As discussed above, the standard single state I-beam cursor (e.g., a cursor shown in FIG. 2) used in many editors is inadequate for editing existing documents with hidden attributes because it is not easily discernable where the attribute mark-up begins or ends. In one embodiment, FIGS. 3 through 5 illustrate a transformation of the standard cursor 200 into a three-state cursor, which includes a standard cursor 200 (see FIG. 3), a left directional cursor 300 (see FIG. 4), and a right directional cursor 400 (see FIG. 5) as implemented by the system depicted in FIGS. 1B-D. This three-state cursor provides greater control and flexibility than the standard single state cursor shown in FIG. 2. The use of the three-state cursor in a text editing environment significantly improves user productivity and reduces rework. Further, the three-state cursor substantially reduces the need for content users to use the “trial and error” method of inserting the cursor next to characters with special formatting, typing, and then determining whether any special attributes affect the newly-typed characters.

In one embodiment, when the three-state cursor is used to edit a structured document with the illustrated attributes as shown in FIG. 2B, with the WYSIWYG display depicted in FIGS. 3 through 5, the cursor display unit 160 configures the three-state cursor wherein the cursor is transitioned through the three states as follows as the document data is traversed.

The cursor display unit 160 configures and displays the three-state cursor as a standard I-beam cursor 200 until a special formatting (attributes such as, for example, underlining, bold, italics, font, etc.) transition is encountered. Therefore, when the cursor is located a position between the beginning point and the endpoint of an attribute, the cursor is displayed in a first state (e.g., an I beam). This first state indicates that a character entered at this point will have the attributes of the adjoining characters. For example, as is shown in FIG. 3, the cursor position corresponds to a location within text located under a bold node or within a begin bold and end bold tag.

The cursor display unit 160 then changes the form of the three-state cursor from the standard cursor 200 to a left 400 or right directional cursor 500 (second or third state) to indicate whether a character entered at that cursor location will be associated with the adjacent attribute (second state, left directional cursor) or will not be associated with the adjacent attribute (third state, right direction attribute). For example, as shown in FIG. 4, a left directional cursor indicates that the cursor is associated with the bold attribute or tags which surround “thing”. In one embodiment moving the cursor one position to the right as shown in FIG. 5, does not result in a change in the displayed position of the cursor but instead changes the state of the cursor to a right cursor to indicate that it is no longer associated with the attributes associated with “thing”.

As shown in FIGS. 4 and 5, a left directional cursor can be represented as “]” and a right directional cursor can be represented as “[”. In other embodiments, other shapes, characters and characteristics of the cursor (e.g., color) can be used to indicate left or right. Further, the size of the cursor can also be varied to indicate the size of the next character to be entered.

As a further example, when an editor is displaying the document shown in FIG. 1 in a WYSIWYG format, the cursor display unit 160 transitions the three-state cursor through all three states as it traverses the text from left to right. When the cursor is between the letters ‘a’ and ‘b’ or between letters ‘b’ and ‘c’, the cursor display unit 160 configures and displays the three-state cursor as a state 1 cursor (e.g., the standard I-beam cursor). When the cursor is between the letters ‘c’ and ‘d’, the cursor display unit 160 configures and displays the three-state cursor as a state 2 cursor (e.g., a left directional cursor) and then as a state 3 cursor (e.g., a right directional cursor). When the cursor is between the letters ‘d’ and ‘e’, the cursor display unit 160 again configures the three-state cursor as a state 1 cursor.

Alternative cursor symbols can be used when the display of the document includes the associated tags. For example, referring back to FIG. 1 the configuration of the three-state cursor when it is between the letters ‘c’ and ‘d’, indicates that there is a bold tag (i.e., <b>) between the two letters. Thus, when the editor is displaying the document with the attribute tags, the cursor can indicate whether it is associated with the content between two tags or the content and the associated tag(s) by using a further type of cursor indicator. For example, when the cursor display unit 160 configures and displays the three-state cursor, positioned between the letters ‘c’ and ‘d’, as a left directional cursor (i.e., as “]<”), the cursor indicates that it is associated with the content only (i.e., ‘abc’), and the subsequently-typed letters will be plain text. When the cursor display unit 160 configures and displays the three-state cursor, positioned between the letters ‘c’ and ‘d’, as a right directional cursor (i.e., as “[>”), the cursor is associated with the content and the associated tag (i.e., ‘<b>def’), and the subsequently-typed letters will be bold.

Determining whether the cursor is associated with the content only or the content and the associated tag(s) is useful for functions other than for determining the format of the subsequently-typed letter(s) for insertion. For example, when the text is highlighted (i.e., selected) for a copying or cutting function, the direction of the cursor shows whether the associated tag(s) is also selected.

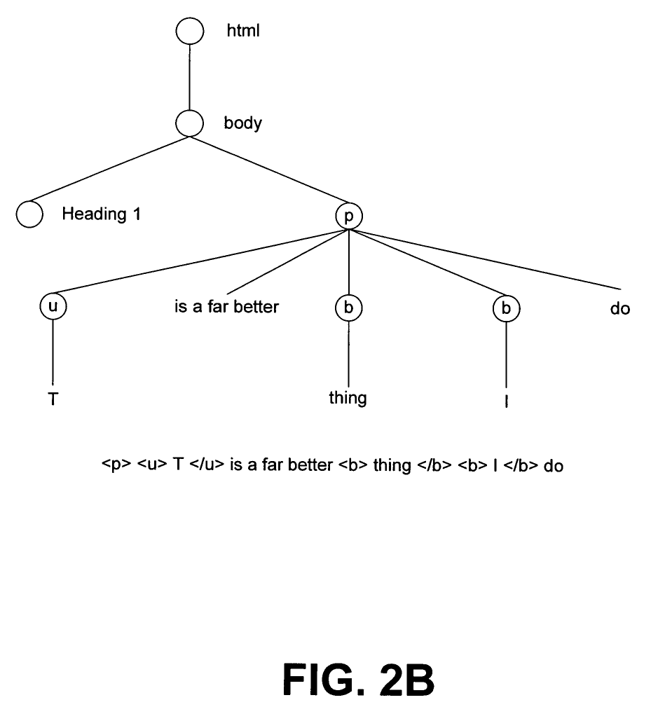

Various embodiments are realized in electronic hardware, computer software, or combinations of these technologies. FIG. 6A shows one representation of a computer system 600 and a user 602. The computer system 600 is configured to be suitable for practicing the embodiments by enabling the use of a multi-state cursor to process a structured or unstructured document. In one example, the computer system 600 provides a data processing unit 615, including a cursor display unit, which configures and displays a multi-state cursor to transition between different states to process a document.

FIG. 6B shows a block diagram of one embodiment of the computer system 600 in FIG. 6A, including the data processing unit 615. The computer system 600 includes a controller 610, a memory 620, storage 630, a media device 640, a user interface 650, an input/output (I/O) interface 660, and a network interface 670. These components are interconnected by a common bus 680. Alternatively, different connection configurations can be used, such as a star pattern with the controller at the center.

The controller 610 is a programmable processor and controls the operation of the computer system 600 and its components. The controller 610 loads instructions from the memory 620 or an embedded controller memory (not shown) and executes these instructions to control the system. In its execution, the controller 610 provides an integrated document editor as a software system. Alternatively, this service can be implemented as separate components in the controller 610 or the computer system 600. The cursor display unit in the data processing unit 615 is configured to control the transitions of a cursor between different states to process a document.

Memory 620 stores data temporarily for use by the other components of the computer system 600, such as for storing document structure information. In one embodiment, memory 620 is implemented as RAM. In one embodiment, memory 620 also includes long-term or permanent memory, such as flash memory and/or ROM.

Storage 630 stores data temporarily or long term for use by the other components of the computer system 600. In one embodiment, storage 630 is a hard disk drive. Storage 630 stores information for use by the data processing unit 615, such as document content or document structure information. Storage 630 also stores data generated by the data processing unit 615.

The media device 640 receives removable media and reads and/or writes data to the inserted media. In one embodiment, the media device 640 is an optical disc drive.

The user interface 650 includes components for accepting user input from a user of the computer system 600 and presenting information to the user. In one embodiment, the user interface 650 includes a keyboard, a mouse, audio speakers, and a display. The controller 610 uses input from the user to adjust the operation of the computer system 600.

The I/O interface 660 includes one or more I/O ports to connect to corresponding I/O devices, such as external storage or supplemental devices (e.g., a printer or a PDA). In one embodiment, the ports of the I/O interface 660 include ports such as: USB ports, PCMCIA ports, serial ports, and/or parallel ports. In another embodiment, the I/O interface 660 includes a wireless interface for communication with external devices wirelessly.

The network interface 670 includes a wired and/or wireless network connection, such as an RJ-45 or “Wi-Fi” interface (802.11) supporting an Ethernet connection.

The computer system 600 includes additional hardware and software typical of computer systems (e.g., power, cooling, operating system), though these components are not specifically shown in FIG. 6B for simplicity. In other embodiments, different configurations of the computer system can be used (e.g., different bus or storage configurations or a multi-processor configuration).

The steps of a method or algorithm or the functions of a module, unit or block described in connection with the embodiments disclosed herein can be embodied directly in hardware, in a software module executed by a processor, or in a combination of the two Furthermore, those of skill in the art will appreciate that the various illustrative logical blocks, modules, units, and method steps described in connection with the above described figures and the embodiments disclosed herein can often be implemented as electronic hardware, computer software, or combinations of both. To clearly illustrate this interchangeability of hardware and software, various illustrative components, blocks, modules, units, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, unit or step is for ease of description. Specific functions or steps can be moved from one module, block or unit to another without departing from the invention.

Various illustrative embodiments have been described. However, one of ordinary skill in the art will see that additional embodiments are also possible. For example, while the above description refers to a three-state cursor, the cursor can be configured to any number of states appropriate for processing a document. In another example, although the above description refers to cursors being configured as having an I-beam shape or other similar shapes, cursors can be configured as having any shape (e.g., crosshair, arrow, etc.) appropriate for accurately tracking the movement of a pointing device or other directional elements. Accordingly, the present invention is not limited to only those embodiments described above.

What is claimed is:

1. A method for processing a document represented by document data including characters and attributes by configuring a multi-state cursor, the method comprising:
manipulating and storing document data according to user input;
processing the document data to display content of the processed document data on a display pane;
configuring and displaying the multi-state cursor in the content display of the display pane to indicate what attributes will be attributed to a character entered at the current cursor position;
transitioning the multi-state cursor from one state to another state when the cursor encounters an attribute change in the content display; and
modifying a configuration of the multi-state cursor when the cursor transitions from one state to another state,
wherein the configuration of the multi-state cursor is modified to enable visual identification of the attribute change.

2. The method of claim 1, wherein the document includes a structured document.

3. The method of claim 1, wherein transitioning the multi-state cursor from one state to another state includes
transitioning from a standard I-beam cursor to a left directional cursor or a right directional cursor.

4. The method of claim 1, wherein modifying a configuration of the multi-state cursor includes
visually indicating whether the cursor is associated with items of the content of the document data between attribute tags.

5. The method of claim 1, wherein modifying a configuration of the multi-state cursor includes
visually indicating whether the cursor is associated with items of the content of the document data and associated attribute tags.

6. A data processing system for processing a document, comprising:
a user interface configured to receive user input;
a document data storage configured to receive and store document data from the document;
a data manipulator configured to receive the document data and the user input, said data manipulator operating to manipulate the received document data according to the user input, and to store the manipulated document data in said document data storage; and
a data display unit configured to process the document data to display content of the processed document data on a display pane, said data display unit including a cursor display unit configuring and displaying the multi-state cursor in the content display of the display pane, wherein the cursor display unit includes:
a state transitioning unit configured to track the current attribute state of the position of the cursor in the display according to the corresponding location in the underlying document data as the cursor traverses the underlying document data; and
a configuration modifier to modify a configuration of the multi-state cursor when the cursor transitions from one state to another state,
wherein the configuration of the multi-state cursor is modified to enable visual identification of the attribute change.

7. The system of claim 6, wherein the document includes a structured document.

8. The system of claim 6, wherein the multi-state cursor includes:
a standard I-beam cursor;
a left directional cursor; and
a right directional cursor.

9. The system of claim 6, wherein the configuration modifier includes a visual indicator to visually indicate whether the cursor is associated with content items between attribute tags.

10. The system of claim 6, wherein the configuration modifier includes
a visual indicator to visually indicate whether the cursor is associated with content items and associated attribute tags.

11. A computer program, stored in a computer-readable storage medium, for processing a document by configuring a multi-state cursor, the program comprising executable instructions that cause a computer to:
manipulate and store document data from the document according to user input;
process the document data to display content of the processed document data on a display pane;
configure and display the multi-state cursor in the content display of the display pane;
transition the multi-state cursor from one state to another state when the cursor encounters an attribute change in the content display; and
modify a configuration of the multi-state cursor when the cursor transitions from one state to another state,
wherein the configuration of the multi-state cursor is modified to enable visual identification of the attribute change.

12. The computer program of claim 11, wherein executable instructions that cause a computer to transition the multi-state cursor from one state to another state includes executable instructions that cause a computer to:
transition from a standard I-beam cursor to a left directional cursor or a right directional cursor.

13. The computer program of claim 11, wherein executable instructions that cause a computer to modify a configuration of the multi-state cursor includes executable instructions that cause a computer to:
visually indicate whether the cursor is associated with content items between attribute tags.

14. The computer program of claim 11, wherein executable instructions that cause a computer to modify a configuration of the multi-state cursor includes executable instructions that cause a computer to:
visually indicate whether the cursor is associated with content items and associated attribute tags.

15. An apparatus for processing a document by configuring a multi-state cursor, comprising:
means for manipulating and storing document data from the document according to user input;
means for processing the document data to display content of the processed document data on a display pane;
means for configuring and displaying the multi-state cursor in the content display of the display pane;
means for transitioning the multi-state cursor from one state to another state when the cursor encounters an attribute change in the content display; and
means for modifying a configuration of the multi-state cursor when the cursor transitions from one state to another state,
wherein the configuration of the multi-state cursor is modified to enable visual identification of the attribute change.
